(19) United States
(12) Patent Application Publication
(10) Pub. No.: US 2012/0264491 A1
(43) Pub. Date: Oct. 18, 2012

(54) Apparatus and method for a storage case attached to the backside of a smart phone

(76) Inventor: Tara Chand Singhal, Torrance, CA (US)

(21) Appl. No.: 13/066,403

(22) Filed: Apr. 14, 2011

(51) Int. Cl. H04M 1/00

(52) U.S. Cl. 455/575.1

(57) ABSTRACT

A storage case for attaching to a side of a smart phone with multiple pockets that are used to store cosmetic and other personal items while the case is attached to the side of the smart phone is described. The case is sized to be about ¼″ inch in thickness and of a height and a width equal to height and width of the backside of the smart phone. The cosmetic case has a frame that is integrally attached to the case and extending out around the edges of the case for placing over and around the four edges of the smart phone with the case on the backside of the phone. The case may be used in conjunction with a grooming mirror in a portable electronic device with a user-facing CCD camera that has a makeup function that when activated activates the user-facing camera on the device.

### CROSS REFERENCE

This application is related to and claims priority from application number yet unassigned, filed on Apr. 7, 2011 by express Mail number EG 610 688 546 US as thus the filing date, titled “System And Method For A Grooming Mirror In A Portable Electronic Device With A User-Facing Camera” of Tara Chand Singhal.

### FIELD OF THE INVENTION

A storage case for attaching to a backside of a smart phone is described. The case has multiple pockets that are used to store makeup or other personal items while the case is attached to the backside of the smart phone and also functions as a protective cover for the smart phone.

### BACKGROUND

Portable wireless communication devices, also known as smart phones, in various form factors and their accessories have become indispensable for the masses for the many features they provide.

It is the objective of the embodiments herein to make such portable electronic devices even more useful to the masses by providing new accessories in such devices.

### SUMMARY

A large segment of the population is made up of women. Almost all of them carry makeup items in their purse or hand bag. These may include any number of items to include at least a small mirror, lipstick and freshening powder.

Almost all these women carry cell phones and now increasingly smart phones. Also the form factor of these phones is slim, with close to quarter of an inch thickness and close to four inches by three inches in size making them convenient to carry on person and in a purse.

An application identified in the Cross Reference section, described an electronic makeup mirror, where the combination of the display screen and the user-facing camera is combined with a makeup function operating in the electronic device that may be used to simulate an electronic makeup or a grooming mirror.

This application teaches a storage case for attaching to the backside of a smart phone. The case has multiple pockets that may be used to store makeup and other personal items while the case is attached to the backside of the smart phone.

The storage case has a frame that is integrally attached to the case and extends out around the edges of the case by a length that is substantially equal to a thickness of the smart phone. The extended out part of the frame is placed over and around the edges of the smart phone with the case on the backside of the phone. Thus the case when attached to the smart phone also functions as a protective cover for the smart phone.

These and other aspects of the embodiments herein are further described in detail with the help of the accompanying drawings and the description, where similar reference number are used to identify the features of the embodiments.

### BRIEF DESCRIPTION OF THE DRAWINGS

Some of the novel features of the embodiments will be best understood from the accompanying drawings, taken in conjunction with the accompanying description, in which similar reference characters refer to similar parts, and in which:

FIG. 1A is a block diagram that illustrates features of the present embodiments of a case for storage of cosmetic items attached to the backside of a smart phone.

FIG. 1B is a block diagram that illustrates features of the present embodiments of a case for storage of personal items attached to the backside of a smart phone.

FIG. 2 is a block diagram that illustrates features of a preferred embodiment of the case attached to the backside of a smart phone.

FIG. 3 is a block diagram that illustrates features of a preferred method embodiment of the case attached to the backside of a smart phone.

### DESCRIPTION

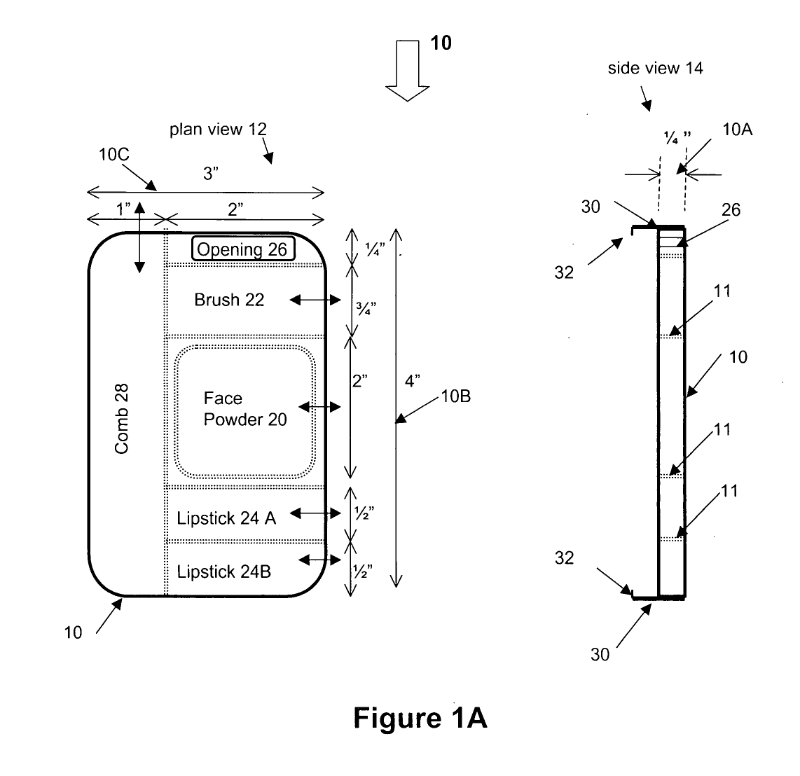

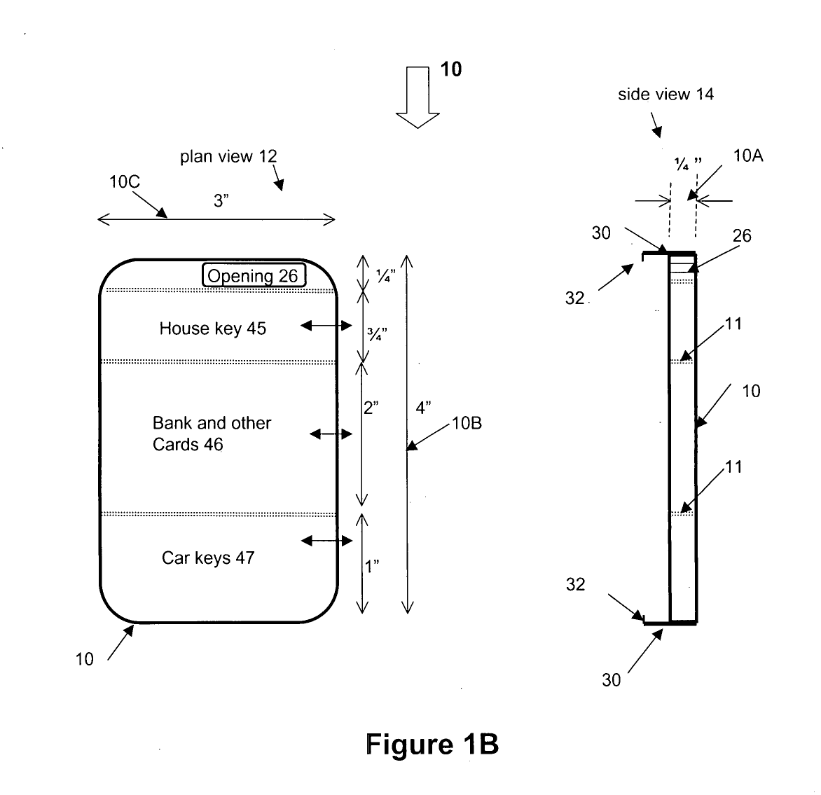

With initial reference to FIGS. 1A and 1B, a storage case 10 for attaching to the backside of a smart phone (not shown) is described with the help of a plan view 12 and a side view 14. The case 10 is of a thickness 10A that may be sized to be from quarter of an inch to one third of an inch in thickness and of a height 10B and a width 10C that are equal to the height and the width of the backside of the smart phone.

As shown in the plan view 12, the case 10 has multiple pockets that may be used to store cosmetic items (as in FIG. 1A) and other personal items (as in FIG. 1B), while the case is attached to the backside side of the smart phone (not shown). As a simplified illustration as in FIG. 1A, cosmetic items such as, a comb 28, lipstick 24, powder 20 and a brush 22 may be stored in the different pockets of the case 10. As a simplified illustration, as in FIG. 1B, personal items such as, a house key 45, a stack of cards 46 and a car key 47 may be stored in different pockets of the case 10.

As shown in the side view 14, the storage case 10 has a frame 30 that is integrally attached to the case 10 and extends out around the edges of the case by a length that is substantially equal to a thickness of the smart phone. The frame 30 is placed over and around the edges of the smart phone with the case 10 on the backside of the smart phone. Thus the case 10 when attached to the smart phone also functions as a protective cover for the smart phone.

The case 10 also has a camera access opening 26 that is used to accommodate a camera on the backside of the smart phone. The case 10 may be made of any suitable material that is used for such cases. These materials may include plastic, rubber, leather, and many other types of man made materials. A pocket partition 11 inside the case 10 between different pockets separates the pockets from each other and also provides a support and structure to the case 10 to maintain the pockets. The pocket partitions 11 may be made of elasticized material to provide snug fit to the various cosmetic and personal items while stored in the pockets.

As illustrated in FIG. 1B, the case 10 may also be used for personal items other than cosmetics. As a simplified illustration the multiple pockets in the case 10 may be configured differently. These pockets may include a pocket 46 for storage of cards that may be bank cards, driver license and other cards as well. The size of pocket 46 of two inch wide, three inches long and a quarter inch in depth would accommodate a number of such cards. Pocket 45 may be used for a house key and pocket 47 may be used for a car key. The pocket 45 may be a three quarter of an inch wide, three inches long and quarter inch deep and may be suitable to store a house key. The pocket 47 may be an inch wide, three inches long and quarter inch deep and may be suitable to store a car key.

Other different sizes and arrangements of the multiple pockets in the case 10 may also be used and are not ruled out. There may be a single pocket, two pockets, three pockets or four pockets based on preferred uses of the case 10.

While women may find it convenient to store cosmetic items, men may find convenient to store personal items as described above that they are likely to carry with them all the time.

A smart phone has acquired such a need and a convenience to masses that they may need to carry that with them in preference to other items. Having all these items in one compact case as part of the smart phone provides a desirable feature.

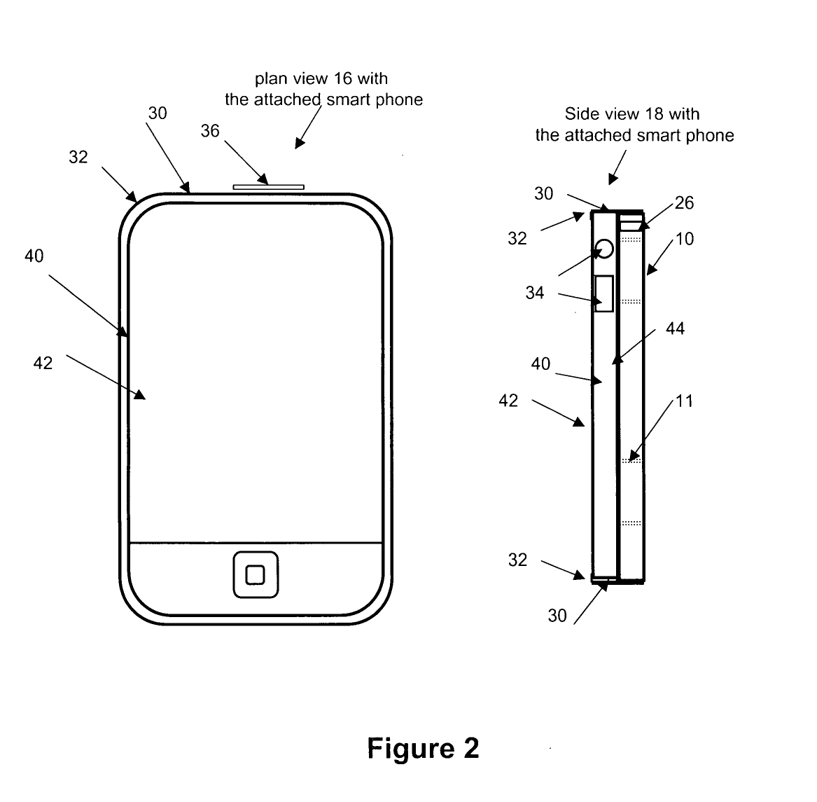

FIG. 2 illustrates the use of case 10 with a smart phone 40. As illustrated in FIG. 2, with a plan view 16 and side view 18, a smart phone 40 has a screen side 42 and a backside 44. The frame 30 is placed over and around the four edges of the phone 40 with the case 10 on the backside 44 of the phone. Thus the case 10 as attached to the phone 40 also functions as a protective cover for the phone 40.

As also illustrated in FIG. 2, the frame 30 has a lip 32 on all sides to be able to hold the smart phone 40 inside the frame 30 and also has suitable cutout 34 that allow access to the controls of the smart phone. In addition a loop 36 may also be provided in the frame 30 at either the top or a corner location. That loop 36 makes it easy for a user to carry and handle the smart phone 40 and the case 10 as a combination.

The case 10 has a preferred thickness 10A of ¼″ to ⅓″. However the thickness 10A may include any thickness of ¼″, 5/16″, 6/16″, 7/16″ or ½ inches. The height 10B and the width 10C of the case 10 substantially equals to four inches by three inches. It is believed that most smart phones are sized to be four inches by three inches.

It should be noted as a matter of common knowledge and observation that while men prefer to carry their smart phones on their body and clothing, women in general prefer to carry their smart phones in their purses. Hence, adding a case 10 to a smart phone 40 does not provide a weight and size inconvenience factor to the smart phone but provides a desirable and convenience factor, as the smart phone 40 and the cosmetic items being stored as separate individual items in the purse in the prior art are stored and accessed as one item with the embodiments described herein.

Due to its great convenience to communicate the smart phone 40 may be used with the same frequency as the desire to review and apply makeup and having the two functions integrated as one package provides a great feature for the women, believed the preferred users of the embodiments herein.

While the pockets in the case 10 have been designed for cosmetic items, the case 10 may be used for other purposes. For example it may be used for a pencil/pen and a paper booklet. Any such other use is not ruled out.

The case 10 may have a vertical oriented pocket that is suitable to store a comb and multiple horizontal oriented pockets to store different cosmetic items. As illustrated in FIG. 1A, the cosmetic case 10 may have five different pockets. These pockets may include a vertical orientation pocket for a comb 28, multiple horizontal pockets for lip stick, 24A and 24B, a top horizontal pocket 22 for a brush and a square pocket 20 for a powder case.

The comb pocket 28 may have a four inch long, one inch wide and quarter inch deep size pocket 28 in the case 10 to accommodate and store a miniature comb sized to the pocket.

The lipstick pocket 24 may have a two inch long, half inch wide and a quarter inch deep size pocket 24 in the case to accommodate and store a lipstick sized to the pocket There may be two different such pockets 24A and 24B. The lipstick may be shaped and sized to fit the pocket size and thus may be of a square or rectangle cross section.

The powder pocket 20 may have a two inch high, two inch wide, and quarter inch deep size pocket 20 in the case 10 to accommodate and store a powder case in the pocket.

The comb pocket 28 has an access opening on the top of the case 10. The other four pockets have their own access openings on the right side of the case 10. These openings allow easy access to the cosmetic items to remove them from the pocket and place them back inside the pocket after use.

These pocket dimensions are believed adequate for storing such cosmetic items. The lipstick pocket is two inch wide, half inch height and quarter inch deep. A miniature version of the lipstick may be created to fit in this pocket size. Same is true for the other pockets that are sized to accommodate the powder case and the brush. As a simplified illustration, the powder pocket 20 is two inch by two inches, a square pocket, and a brush pocket is two inches by three quarters of an inch.

A camera access opening 26 of approximately one inch wide and quarter inch high and deep is set aside to accommodate a back facing camera and light. The camera access opening 26 on a backside of the smart phone is on the top of the phone and to one side. The position of camera access opening 26 on the case 10 is adjusted for different phone models.

In an alternative embodiment, the case 10 may itself store a mirror as part of the powder case. Prior art teaches a powder case with a mirror in the lid of the powder case. Such a powder case may be used in lieu of or in addition to the electronic mirror.

While the embodiments described herein are for a non-slide smart phone, the embodiments herein may also be adapted for smart phones with slide open features and they are not ruled out.

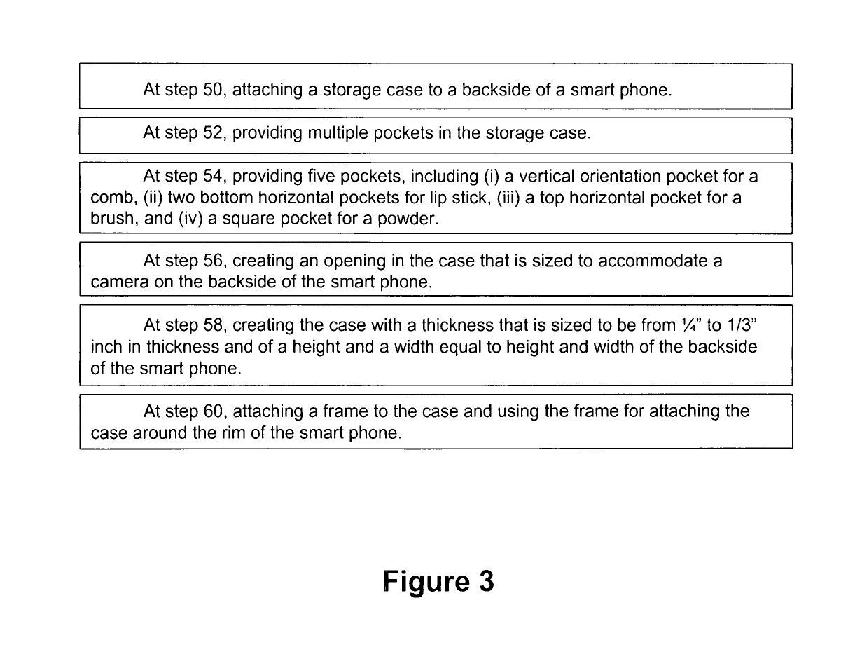

Method of Operation As illustrated in FIG. 3, a method of operation has the following steps where all the steps may not be used or used in the order specified.

At step 50, attaching a storage case to a backside of a smart phone.

At step 52, providing multiple pockets in the storage case.

At step 54, providing five pockets, including (i) a vertical orientation pocket for a comb, (ii) two bottom horizontal pockets for lip stick, (iii) a top horizontal pocket for a brush, and (iv) a square pocket for a powder.

At step 56, creating a camera access opening in the case that is sized to accommodate a camera on the backside of the smart phone.

At step 58, creating the case with a thickness that is sized to be from ¼″ to ⅓″ inch in thickness and of a height and a width equal to height and width of the backside of the smart phone.

At step 60, attaching a frame to the case and using the frame for attaching the case around the rim of the smart phone.

As a simplified illustration of the mode of operation of the embodiments herein, a user would take out a smart phone from the packet. Activate the makeup function to see the face features. The user then can easily reach inside the case 10 to pull out what ever item is desired for use from a pocket and then put it back in the pocket. As an alternative, the case 10 may be used to access one or more cards and a house and a car key.

In summary, the preferred embodiments are on a storage case that is attached to the backside of a smart phone and may be used either in conjunction with a makeup mirror in a portable electronic device with a user-facing CCD camera that has a makeup function that when activated activates the user-facing camera on the device, the camera captures images of a user's face and displays live images of the user face on the screen, wherein, the device functions as a grooming mirror for the user. Alternatively, the case 10 may itself store a mirror as part of the powder case.

While the particular invention, as illustrated herein and disclosed in detail is fully capable of obtaining the objective and providing the advantages herein before stated, it is to be understood that it is merely illustrative of the presently preferred embodiments of the invention and that no limitations are intended to the details of construction or design herein shown other than as described in the appended claims.

1. A storage case for personal items, in smart phones and handheld electronic devices, comprising:
a. a flat storage case for attaching to a backside of a smart phone;
b. the case has multiple pockets that are used to store personal items while the case is attached to the backside of the smart phone.

2. The case as in claim 1, comprising:
the case is of a thickness that is sized to be from ¼″ to ⅓″ inch in thickness and of a height and a width equal to height and width of the backside of the smart phone.

3. The case as in claim 1, comprising:
a frame that is integrally attached to the case and extends out around the edges of the case;
the frame is placed over and around the four edges of the phone with the case on the backside of the phone, thus the case is attached to the phone to also functions as a protective cover for the phone.

4. The case as in claim 3, comprising:
the frame has a lip on all sides to be able to hold the smart phone inside the frame and also has suitable openings that allow access to the controls of the smart phone.

5. The case as in claim 1, comprising:
the case is of a thickness that includes a thickness of 1/4″, 5/16″, 6/16″, 7/16″ or 1/2 inches and of a height and a width substantially equal to four inches by three inches.

6. The case as in claim 1, comprising:
five pockets, including (i) a vertical orientation pocket for a comb, (ii) two bottom horizontal pockets for lip stick, (iii) a top horizontal pocket for a brush and (iv) a square pocket for a powder.

7. The case as in claim 1, comprising:
the case has a camera access opening that is sized to accommodate a camera on the backside of the smart phone.

8. The case as in claim 1, comprising:
the case has a vertical oriented pocket to store a comb and multiple horizontal oriented pockets to store cosmetic items.

9. The case as in claim 1, comprising:
a two inch long, half inch wide and a quarter inch deep size pocket in the case to accommodate and store a miniature lipstick sized to the pocket.

10. The case as in claim 1, comprising:
a four inch long, a one inch wide and a quarter inch deep size pocket in the case to accommodate and store a miniature comb sized to the pocket.

11. A storage case, for attaching to a side of a smart phone, comprising:
a. a flat storage case for attaching to a side of a smart phone; the case has multiple pockets that are used to store personal items while the case is attached to the backside of the smart phone;
b. the case has a frame that is integrally attached to the case and extending out around the edges of the case, the frame is placed over and around the four edges of a smart phone with the case on the backside of the phone, thus the case also functions as a protective cover for the phone.

12. The case as in claim 11, comprising:
five pockets, including (i) a vertical orientation pocket for a comb, (ii) two bottom horizontal pockets for lip stick, (iii) a top horizontal pocket for a brush and (iv) a square pocket for a powder.

13. The case as in claim 11, comprising:
the case has a camera access opening that is sized to accommodate a camera on the backside of the smart phone.

14. The case as in claim 11, comprising:
the case is of a thickness that is sized to be from ¼″ to ⅓″ inch in thickness and of a height and a width equal to height and width of the backside of the smart phone.

15. A method for a storage case for a smart phone, comprising the steps of:
attaching a storage case to a backside of a smart phone

16. The method as in claim 15, further comprising the steps of:
providing multiple pockets in the storage case.

17. The method as in claim 16, further comprising the steps of:
providing five pockets, including (i) a vertical orientation pocket for a comb, (ii) two bottom horizontal pockets for lip stick, (iii) a top horizontal pocket for a brush and (iv) a square pocket for a powder.

18. The method as in claim 16, further comprising the steps of:
providing three different pockets, two horizontally orientated pockets for storage of keys and one horizontally orientated pocket for storage of bank and other types of cards.

19. The method as in claim 15, further comprising the steps of:
creating the case with a thickness that is sized to be from ¼″ to ⅓″ inch in thickness and of a height and a width equal to height and width of the backside of the smart phone.

20. The method as in claim 15, further comprising the steps of:
attaching a frame to the case and using the frame for attaching the case around the rim of the smart phone.
